(19) United States
(12) Patent Application Publication
(10) Pub. No.: US 2014/0142478 A1
(43) Pub. Date: May 22, 2014

(54) Portable Arm Massager

(71) Applicant: Lalkrushna C. MALAVIYA, Philadelphia, PA (US)

(72) Inventor: Lalkrushna C. MALAVIYA, Philadelphia, PA (US)

(21) Appl. No.: 14/084,061

(22) Filed: Nov. 19, 2013

Related U.S. Application Data
(60) Provisional application No. 61/728,125, filed on Nov. 19, 2012.

(51) Int. Cl. A61H 15/00

(52) U.S. Cl. CPC A61H 15/0078
USPC 601/115

(57) ABSTRACT

A portable arm massager has an arm cuff supported by a supporting base. The arm cuff has two cuff portions connected by a hinge, allowing the cuff to open so that a user may place their arm within the cuff. The cuff may be switched from a left to right position for the user's left or right arm, or two stationary cuffs may be used. A plurality of massaging rollers on the internal surface of the cuffs provides massage pressure. A control panel allows multiple users to change a variety of massage settings which can be saved and recalled as personal presets.

The current application claims a priority to the U.S. Provisional Patent application Ser. No. 61/728,125 filed on Nov. 19, 2012.

### FIELD OF THE INVENTION

The present invention relates generally to massages. More particularly, the present invention relates to an apparatus for an arm massaging machine.

### BACKGROUND OF THE INVENTION

Massage is the manipulating of superficial and deeper layers of muscle and connective tissue using various techniques to enhance function, aid in the healing process, decrease muscle reflex activity, inhibit motor-neuron excitability and promote relaxation and well-being. Massage involves working or acting on the body with different techniques such as structured, unstructured, stationary, or moving pressure, tension, motion, or vibration, manually or with mechanical aids. Target tissues may include muscles, tendons, ligaments, fascia, skin, joints, or other connective tissue, as well as lymphatic vessels or organs of the gastrointestinal system. Peer-reviewed medical research has shown that the benefits of massage include pain relief, reduced trait anxiety and depression, and temporarily reduced blood pressure, heart rate, and state of anxiety.

In many office jobs, employees spend the majority of the workday sitting at a desk using a computer. Typing on a keyboard and using the mouse to control the computer may become quite stressful on a user's hands and arms over long periods of time, and may contribute to carpal tunnel syndrome (CTS). In fact, according to the National Center for Biotechnology Information, the most common cause of CTS is typing. Carpal tunnel syndrome is an entrapment median neuropathy, causing paresthesia, pain, numbness, and other symptoms in the distribution of the median nerve due to its compression at the wrist in the carpal tunnel. In many locations, workers diagnosed with CTS are entitled to time off and compensation. In the USA, CTS results in an average of $30,000 in lifetime costs, including medical bills and lost time from work. Businesses where the employees do a lot of typing are likely to benefit from having the employees' hands and arms massaged, to prevent CTS as well as relieve stress and promote general feelings of well-being. However, massage therapists typically charge high rates and are not economical for a business to provide to their employees or for long term therapy.

Many massaging machines exist, which have the advantage that the cost to acquire the machine is a one-time purchase, versus paying per session with a massage therapist. Massaging machines commonly take the form of chairs a person sits in, which massages the person's head, neck, back, buttocks, or legs. Massaging machines specifically for massaging one's legs exist, typically used by sitting in a chair with the leg massaging machine resting on the floor. However, few or no arm massaging machines exist. It would be beneficial for businesses that involve significant amounts of typing to provide its employees with a hand and arm massager to relieve stress and prevent carpal tunnel syndrome. In offices with many employees using a massaging machine, it is desirable to have programmable massage setting presets in order to personalize the massage for each employee and not have to program the machine to the desired settings with each new session. A portable arm massager may also be desired for use in the home, so that a person with CTS may use it on their own time. It could also benefit persons with blood circulation problems. It is therefore an object of the present invention to provide a portable arm massaging machine with programmable massage setting presets.

### BRIEF DESCRIPTION OF THE DRAWINGS

FIG. 1 is a perspective view of the preferred embodiment of the present invention with the arm cuff being rotatable and positioned on the left side.

FIG. 2 is a perspective view of the preferred embodiment of the present invention with the arm cuff being rotatable and positioned on the right side.

FIG. 3 is a front view of the preferred embodiment of the present invention with the arm cuff positioned on the left side.

FIG. 4 is a perspective view of the second embodiment of the present invention with two closed, retracted arm cuffs, without the inner cuff liners for a view of the massaging rollers.

FIG. 5 is a perspective view of the second embodiment of the present invention with two closed, extended arm cuffs and without the inner cuff liners.

FIG. 6 is a perspective view of the second embodiment of the present invention without the inner cuff liners, with cylindrical rollers in combination with ball rollers, with the cuffs in the open position.

FIG. 7 is a side view of the present invention without the inner cuff liner showing the kill switch and tilting functionality.

FIG. 8 is a perspective view of the third embodiment of the present invention with a single, stationary arm cuff.

FIG. 9 is a block diagram describing the electrical connections for the power source.

FIG. 10 is a block diagram describing the electronic connections for the chipset.

### DETAIL DESCRIPTIONS OF THE INVENTION

All illustrations of the drawings are for the purpose of describing selected versions of the present invention and are not intended to limit the scope of the present invention.

The present invention is a portable arm massager capable of personalizing and storing massage presets for multiple users. A user places their arm within an arm cuff 2 which has internal massaging rollers 3 which apply pressure to the user's arm in various amounts, locations, or patterns according to desired settings which can be stored as presets and recalled for future use. The present invention generally comprises a supporting base 1, an arm cuff 2, a plurality of massaging rollers 3, a control panel 4, a chipset 5, and a power source 6. The arm cuff 2 and the control panel 4 are connected to the supporting base 1, and the plurality of rollers is positioned within the arm cuff 2.

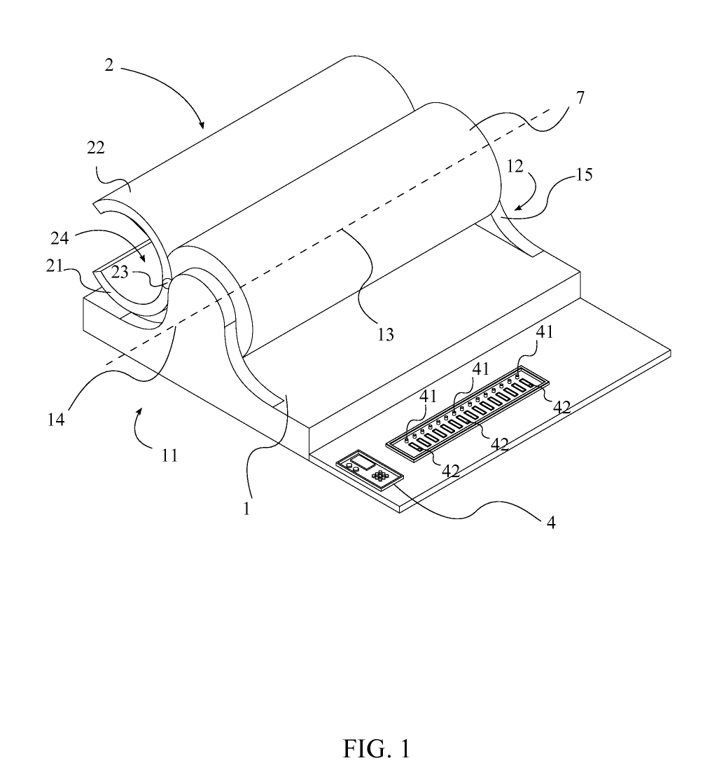

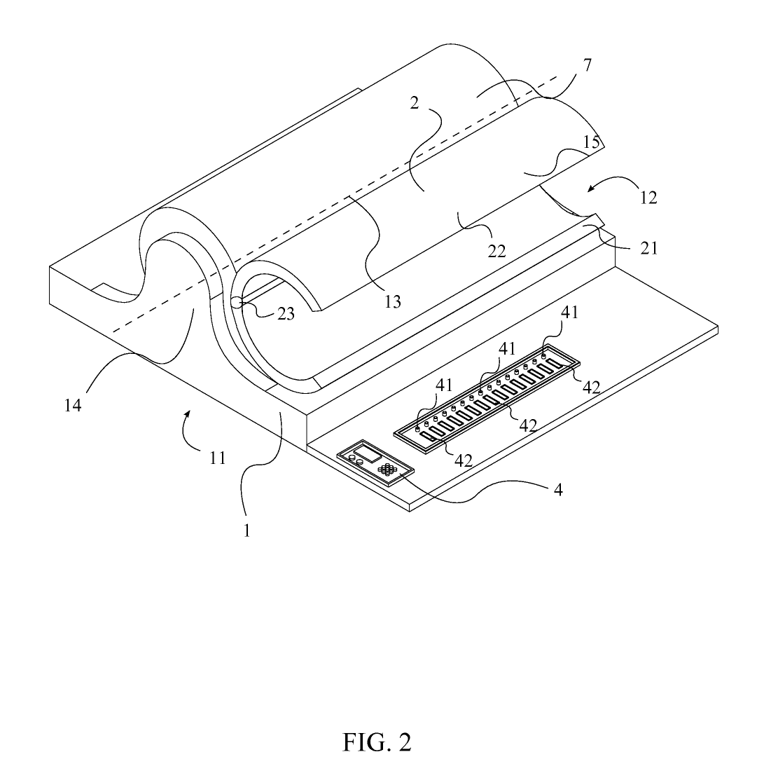

Referring to FIGS. 1-2, in the preferred embodiment of the present invention, the supporting base 1 is generally rectangular or trapezoidal and longitudinally elongated with transverse symmetry about an axis hereinafter referred to as the central axis 13, which is the direction a user faces to use the present invention. The central axis 13 defines a longitudinal direction for the present invention. In general, the present invention is placed on a table or another elevated surface, so that the user may sit in a chair adjacent to the table and place their arm within the arm cuff 2. A first end 11 and a second end 12 of the supporting base 1 are positioned opposite each other on the supporting base 1 along the central axis 13, with the first end 11 being where the user positions themselves to use the present invention.

In a first embodiment of the present invention shown in FIGS. 1-3, the arm cuff 2 may be moved to either a left or right lateral position atop the supporting base 1 so that the user has the option to massage either their left or right arm using the present invention. To this end, the present invention additionally comprises a cuff support 7 and the supporting base 1 comprises a first support arm 14 and a second support arm 15. The first support arm 14 and the second support arm 15 are structural elements oriented perpendicular to the central axis 13 and raised above the supporting base 1. The first support arm 14 is positioned at the first end 11 of the supporting base 1, and the second support arm 15 is positioned at the second end 12 of the supporting base 1. The cuff support 7 is an elongated structural member oriented parallel to the central axis 13 and rotatably fixed between the first support arm 14 and the second support arm 15. Thus, the cuff support 7 is translationally fixed, but allowed to rotate axially. The arm cuff 2 is fixed to the cuff support 7 in order to allow the arm cuff 2 to be rotated to either the left position of the right position. Since the arm cuff 2 is fixed to the cuff support 7, rotating the cuff support 7 by a desired angle also rotates the arm cuff 2 by the desired angle, thereby allowing the arm cuff 2 to be rotated between the left position and the right position.

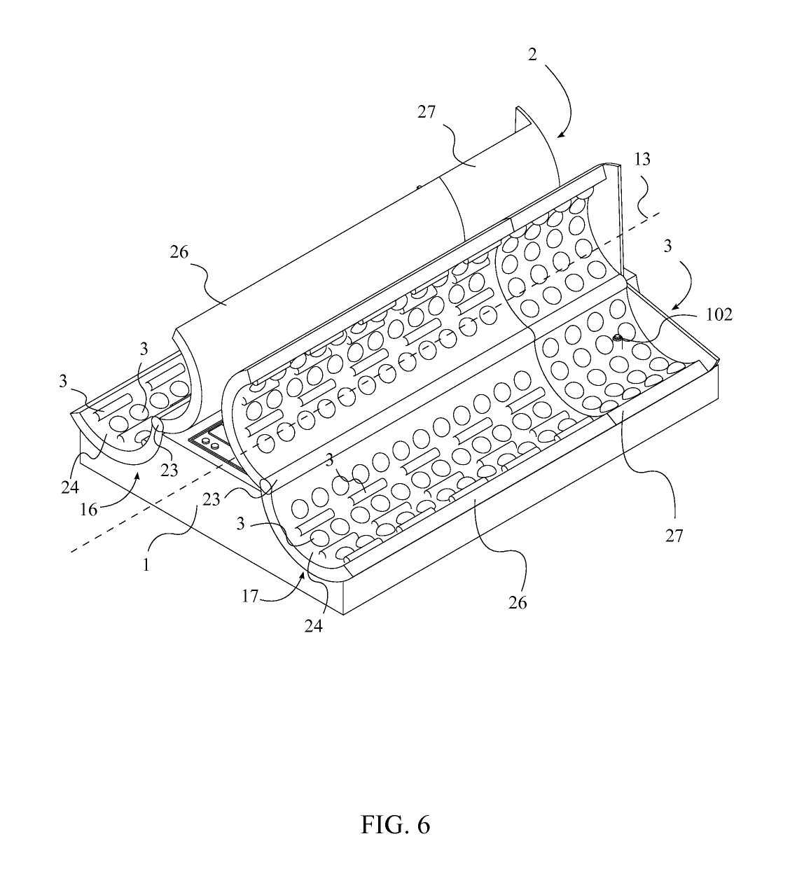

The arm cuff 2 is generally elongated with a cylindrical or ovular cross-section with a lateral opening so that the cross section resembles a C shape. The arm cuff 2 traverses across the supporting base 1 from the first end 11 to the second end 12 and is supported by the supporting base 1. In the preferred embodiment of the present invention, the arm cuff 2 comprises a first cuff portion 21, a second cuff portion 22, and a hinge 23, as can be seen in FIGS. 1-3. The first cuff portion 21 and the second cuff portion 22 refer to radial portions of the cross-section of the arm cuff 2; that is, cross-sections for the first cuff portion 21 and the second cuff portion 22 do not change along the length of the arm cuff 2. The first cuff portion 21 and the second cuff portion 22 each comprise approximately half of the C shape of the cross section of the arm cuff 2. The first cuff portion 21 and the second cuff portion 22 are hingedly connected to each other by a hinge 23, which is oriented parallel to the central axis 13. Thus, the arm cuff 2 opens and closes by rotating the first cuff portion 21 and/or the second cuff portion 22 relative to each other about the hinge 23, as illustrated in FIG. 6. This allows the user to utilize the present invention by opening the arm cuff 2 as previously described, placing their arm within the arm cuff 2, and closing the arm cuff 2. Preferably, a cuff is not so tight around the user's arm that the user is not able to forcibly remove their arm from the cuff without disengaging the cuff from their arm. In the preferred embodiment, the hinge 23 is the component of the arm cuff 2 that is connected to the cuff support 7, though other connection means may be employed as appropriate in alternate embodiments. For example, in an alternate embodiment the first cuff portion 21 and the second cuff portion 22 are not connected by a hinge facilitating rotational movement for opening the arm cuff 2, but rather open by linearly translating relative to each other. For example, the first cuff portion 21 and the second cuff portion 22 are connected by a sliding mechanism or a telescoping mechanism that allows the first cuff portion 21 and the second cuff portion 22 to separate from each other horizontally or vertically.

The arm cuff 2 may be opened by angularly separating the first cuff portion 21 and the second cuff portion 22 manually, or the arm cuff 2 may be opened by an electric motor, pneumatic system or hydraulic system, or other electrical or mechanical means as appropriate.

In alternate embodiments of the present invention, the user may place their arm within the arm cuff 2 through alternate means, such as, but not limited to, the arm cuff 2 being a single rigid piece with a lateral slot sufficiently wide enough for a user to slide their arm through, or having no lateral slot and having the user insert their arm longitudinally into the arm cuff 2 at the first end 11. Additionally contemplated is an embodiment where the arm cuff 2 comprises a slot adjacent to a user's proximal arm area and no slot adjacent to the user's distal hand area.

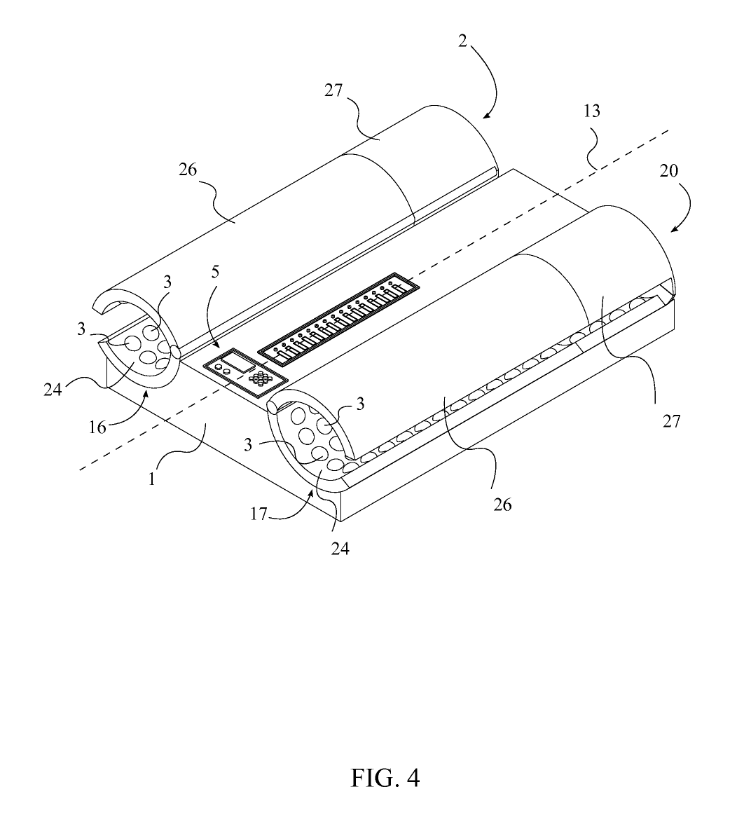

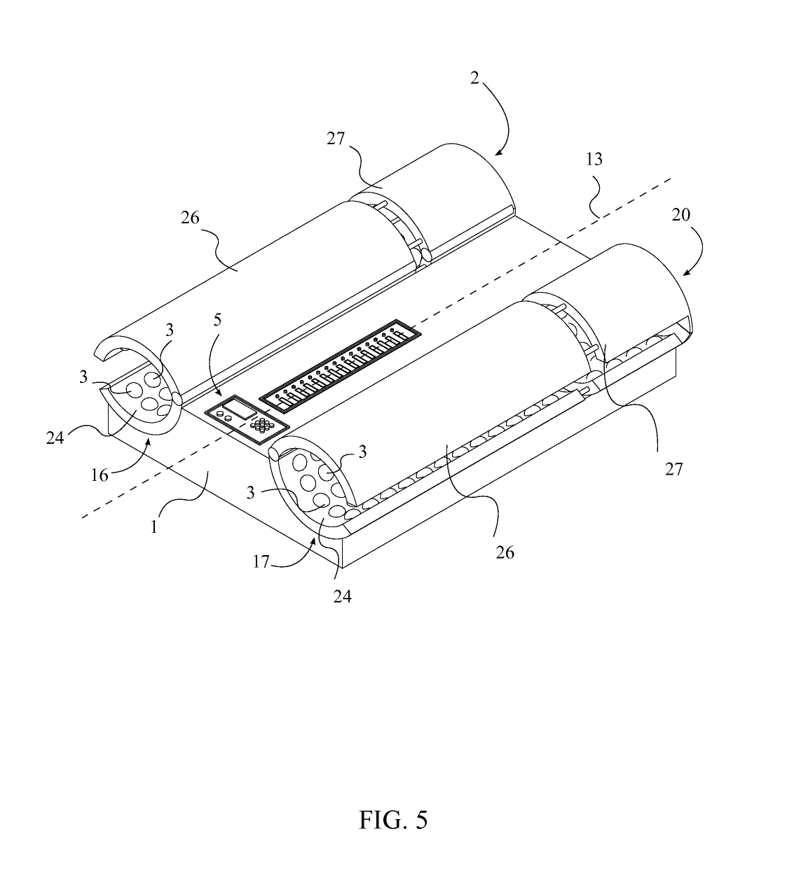

As can be seen in FIGS. 4-5, in the preferred embodiment of the present invention, the arm cuff 2 is able to extend in order to accommodate users with long arms. To this end, the arm cuff 2 comprises a main section 26 and an extension section 27. The main section 26 is the majority of the length of the arm cuff 2, and is positioned adjacent to the first end 11. The extension section 27 is positioned adjacent to the main section 26 opposite the first end 11 and adjacent to the second end 12. The extension section 27 is slidably connected to the main section 26, wherein the extension section 27 is allowed to translate away from the main section 26 with a telescoping action in order to increase the total length of the arm cuff 2. The extension section 27 may also comprise protrusions that slide along tracks in the main body of the cuff to facilitate extending the cuff, or another method to allow the length of the cuff to be extended. The extension section 27 is preferably extended by the user applying longitudinal pressure to the far extremity of the inside of the cuff against force of a spring or plurality of springs that function to hold the extension section 27 in its unextended position when no force is applied. Each cuff also comprises a depression on the near end of the lower portion for the user to rest their elbow in. In one embodiment of the present invention, the extension section 27 may open and close independently of the massaging cuff.

The plurality of massaging rollers 3 is distributed across an internal surface 24 of the arm cuff 2, wherein the internal surface 24 is adjacent to and envelops the user's arm when the present invention is in use. In the preferred embodiment of the present invention, each of the plurality of massaging rollers 3 comprises a roller activation mechanism 31, wherein the roller activation mechanism 31 enables one of the massaging rollers 3 to be maneuvered for massage purposes. In one embodiment of the present invention, the roller activation mechanism 31 is a mechanical arm connected to a roller which controls the motion of the roller. In alternate embodiments, any other previously known technology for delivering massage pressure may be utilized.

In one embodiment of the present invention, the massaging rollers 3 are spherical and are held within the body of the arm cuff 2 and traversing through the internal surface 24, and allowed to rotate in a manner similar to ball bearings. In another embodiment of the present invention, each of the massaging rollers 3 resembles a tire or a cylinder. In the preferred embodiment, the massaging rollers 3 cover several primary massage points, such as, but not limited to, the user's palm, wrist, under the elbow, and forearm muscle groups. In the preferred embodiment of the present invention, there are two sets of massaging rollers 3: one set for the forearm and one set for the hand. The massaging rollers 3 may all be of uniform size, or the massaging rollers 3 may be of different sizes to accommodate differently shaped areas of the arm or hand. The present invention also preferably comprises other elements conducive to massage, such as, but not limited to, heating elements, cooling fans, or vibrating motors. Another embodiment of the present invention comprises an additional massaging mechanism, which is preferably a separate C shaped attachment for massaging the arm, or which is a secondary mechanism built into the present invention in addition to the primary massager.

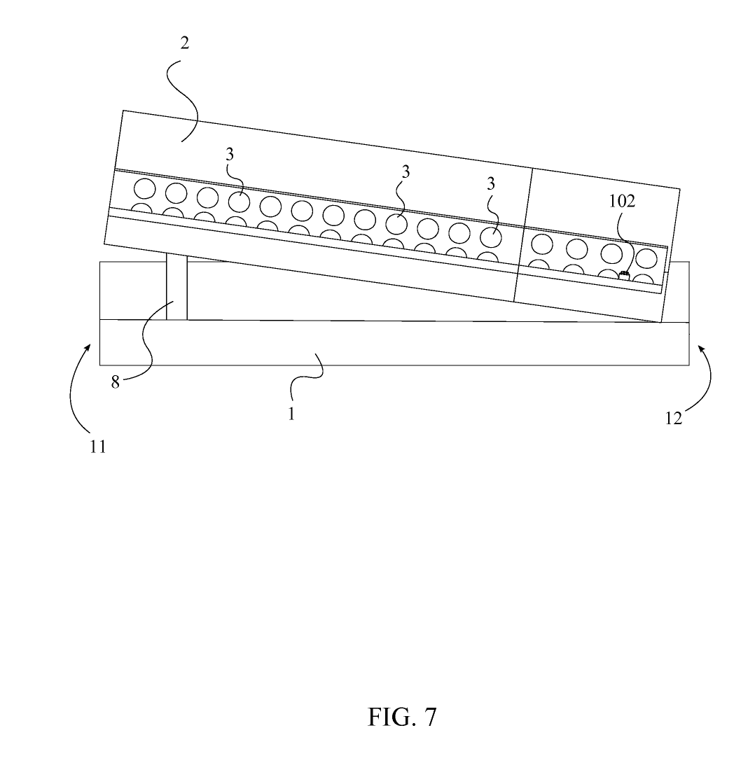

Referring to FIG. 7, in one embodiment of the present invention, the arm cuff 2 is able to be angled upwards or downwards by a cuff elevating mechanism 8. The cuff elevating mechanism 8 is operatively connected between the cuff and the supporting base 1. Preferably, the cuff elevating mechanism 8 is positioned at the first end 11 of the supporting base 1 so that the cuff elevating mechanism 8 elevates the end of the main section 26 of the arm cuff 2 adjacent to the first end 11 of the supporting base 1. In the preferred embodiment, the cuff elevating mechanism 8 utilizes a mechanical arm that extends upward, applying force to the arm cuff 2 in order to elevate the arm cuff 2. In an alternate embodiment, the cuff elevating mechanism 8 is an inflatable bladder positioned underneath the arm cuff 2. The inflatable bladder is filled with air or another gas in order to inflate the bladder and thereby raise the arm cuff 2. In another embodiment of the present invention, the cuff is raised and lowered manually, with a locking mechanism such as a spring-loaded pin and a series of holes or a ratcheting mechanism to secure the cuff at the desired angle. In the preferred embodiment of the present invention, the position of the arm cuff 2 can additionally be adjusted in a horizontal plane in order to provide the user with options for more comfortable arm positions. In this embodiment, the arm cuff 2 is able to slide laterally along the supporting base 1, wherein preferably both ends (proximal or distal) of the arm cuff 2 are able to be moved laterally in order to adjust the horizontal angle of the arm cuff 2.

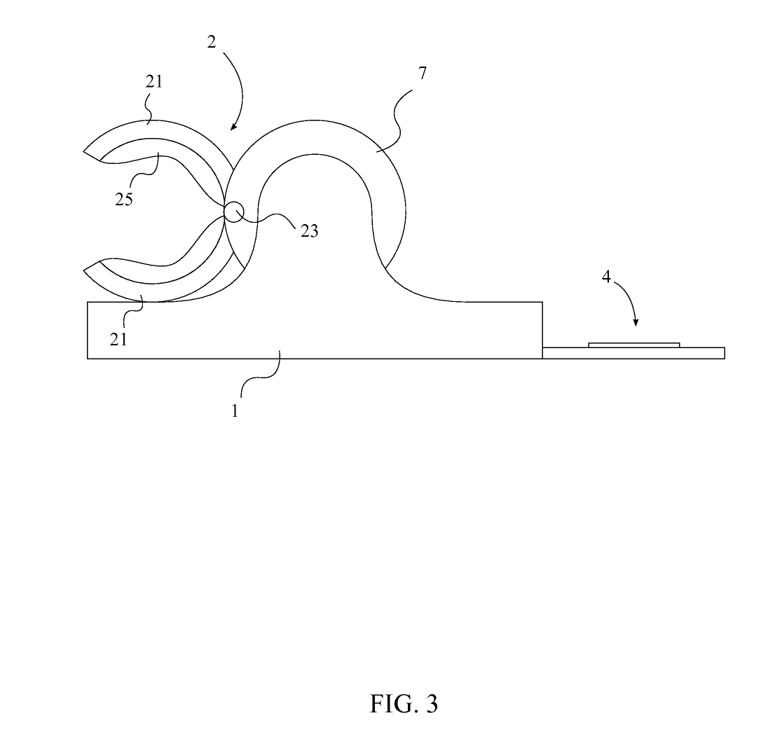

Referring to FIG. 3, in the preferred embodiment of the present invention, the arm cuff 2 comprises an inner cuff liner 25 that covers the internal surface 24 of the arm cuff 2, so that the mechanisms of the massaging rollers 3 are not exposed. The inner cuff liner 25 may be made out of any suitable material, including, but not limited to, vinyl, plastic, or rubber. In one embodiment of the present invention, the inner cuff liner 25 may be pumped full of air to facilitate measuring the user's blood pressure, and additional sensors or other means may be utilized to measure the user's heart rate, which can be displayed on the control panel 4 or a separate display. In the preferred embodiment of the present invention, the inner cuff liner 25 can have antimicrobial properties. The inner cuff liner 25 may also be sanitized by an ultraviolet light or a sanitizing spray, which may be activated manually or automatically after each use. Additionally, a user may insert their hand and arm into a separate liner made of latex, rubber, vinyl, cloth or another suitable material. The separate liner is essentially a glove, but extended to cover the length of the user's arm. The separate liner may be disposable or it may be made of cloth, so that a user has their own personal liner that they take home and wash when the massager is used by multiple persons, in an office setting, for example.

The control panel 4 is a commonly known element comprised of electronic components such as a circuit board and processor which facilitates user control of the present invention. In the preferred embodiment of the present invention, the control panel 4 is an electronic touchscreen, wherein the user interfaces with the present invention by pressing their finger against digital images representing buttons on the touchscreen. In another embodiment, the control panel 4 comprises a plurality of physical push buttons including a plurality of preset selection buttons 41. In the first embodiment, the control panel 4 is preferably positioned laterally adjacent to the supporting base 1, although it is contemplated that the control panel 4 may be positioned in alternate locations, such as, but not limited to, longitudinally adjacent to the supporting base 1 adjacent to the first end 11.

The control panel 4 allows users to select a variety of settings for their massage session, including, but not limited to, the type of massage, vibration or pulse, intensity or pattern, heat or cooling, time duration of the massage session, or amount of pressure applied by the massaging rollers 3. As appropriate for various embodiments, the control panel 4 may also allow a user to adjust the extension of the extension section 27, open or close the massaging cuffs, or change the angle or elevation of the massaging cuffs. The plurality of preset selection buttons 41 allow a user to store personalized settings so that they do not have to reprogram the massage settings to their personal massage preferences every time they wish to utilize the present invention. In the preferred embodiment of the present invention, to program a preset, a user selects all the massage settings they wish, and then long press a preset selection button until a signal such as a beep is given, indicating that the preset has been stored. In the embodiment with physical push buttons, each preset selection button has a name placard 42 next to it which users may write their name on. In another embodiment, the name placards 42 are digital screens. The control panel 4 may also allow a user to select a number of preprogrammed massage settings, such as, but not limited to, a carpal tunnel syndrome relief massage setting. One embodiment of the present invention comprises a wireless or wired network connection interface, so that presets or other settings may be adjusted from a computer, mobile device or other interface.

Additional elements to be incorporated into the preferred embodiment of the present invention include at least one sensor 101 and a kill switch 102. The at least one sensor 101 is positioned within the arm cuff 2 in order to sense when the user places their arm into the arm cuff 2. Using the at least one sensor 101, a functionality may be added to the present invention wherein massaging action may be triggered automatically upon sensing that the user has placed their arm within the arm cuff 2. The kill switch 102 is a button located within the arm cuff 2 adjacent to the second end 12, where the user's hand would be while the present invention is in use. The kill switch 102 provides the user with the option to instantly stop any massaging action by the plurality of massaging rollers 3 if the user becomes uncomfortable at any time during the massage.

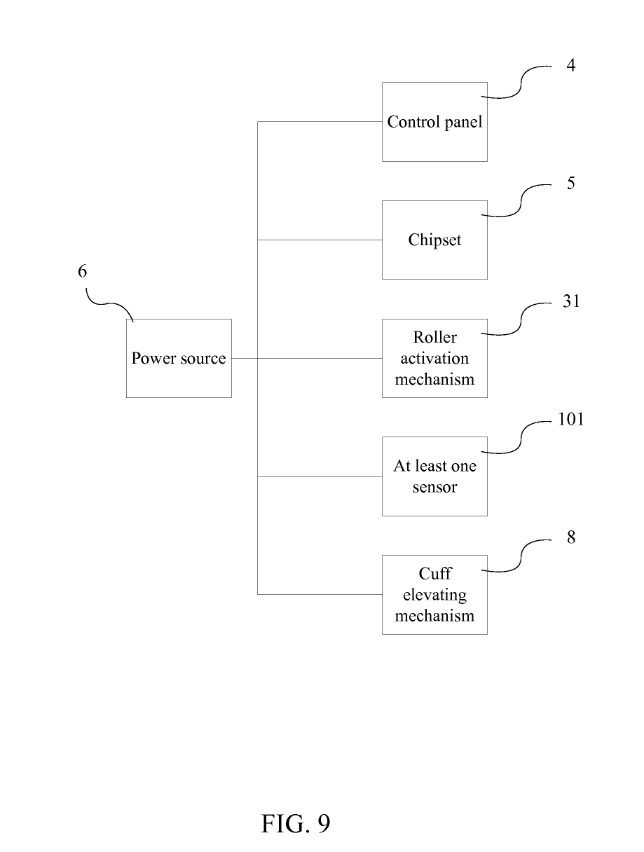

The power source 6 may be any source of electrical power appropriate for providing the necessary voltage for operating the present invention. The power source 6 may be a permanent internal battery which can be recharged, or the present invention may utilize common interchangeable batteries such as, but not limited to, AA, AAA, C or D type batteries. The power source 6 may also be a power cord which must be plugged into a typical electrical wall outlet, or the power source 6 may be any combination of the aforementioned power source 6s. Referring to FIG. 9, the power source 6 is electrically connected to and provides electrical power to the control panel 4, chipset 5, the roller activation mechanism 31 for each of the plurality of massaging rollers 3 and other massage elements as appropriate, the at least one sensor 101, and to the cuff elevating mechanism 8 as appropriate.

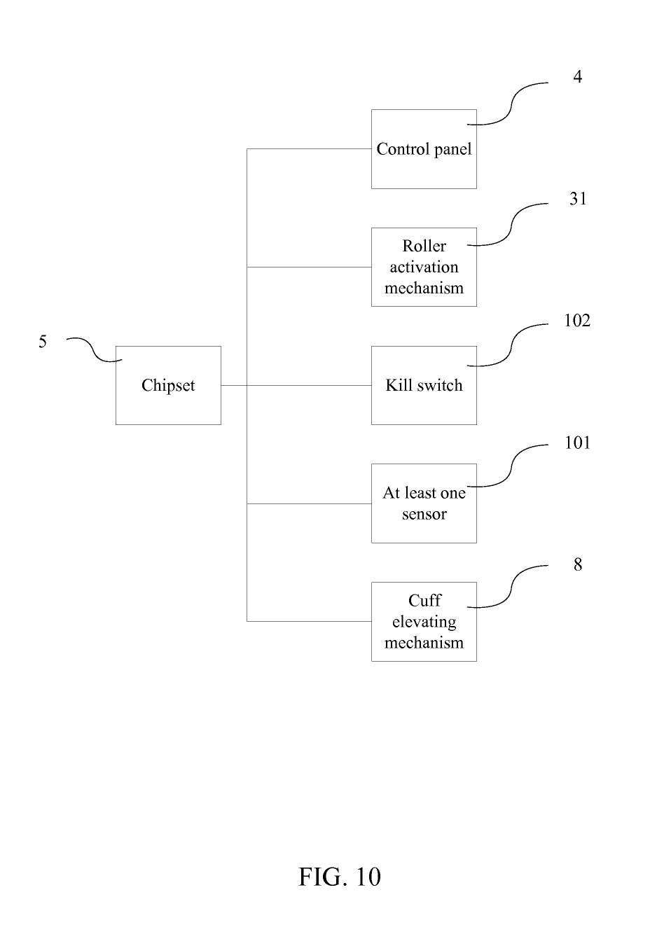

The chipset 5 is a component or combination of components of the electronic variety such as, but not limited to, circuit boards, wires, and processors necessary to facilitate the translation of electrical input signals into desired effects in the operation of the present invention. The chipset 5 receives electrical inputs from various sources, such as, but not limited to, the control panel 4, the at least one sensor 101, the kill switch 102, or the network communication device, processes the inputs, and produces the appropriate outputs, such as, but not limited to, signals to control the control panel 4, signals to control the roller activation mechanism 31 for each of the massaging rollers 3, signals to control the cuff elevating mechanism 8, signals to play audio through a speaker, play video or commands through a network connection to perform functions such as, but not limited to, sending an email, or adding an email address, phone number or other information to a database, where said information would be received through the control panel 4. Referring to FIG. 10, the chipset 5 is electronically connected to the control panel 4, the roller activation mechanism 31 of each of the plurality of massaging rollers 3, the kill switch 102, the at least one sensor 101, and the cuff elevating mechanism 8 as appropriate in various embodiments of the present invention.

In a second embodiment of the present invention illustrated in FIGS. 4-6, two separate arm cuffs are used instead of a single arm cuff which can be switched from a left position to a right position and vice versa. The second embodiment comprises the arm cuff 2 (hereinafter referred to as the first arm cuff 2) and a second arm cuff 20 comprising a first cuff portion 21, an upper cuff portion, and a hinge 23, with the plurality of massaging rollers 3 being additionally distributed across an internal surface 24 of the first arm cuff 2 and of the second arm cuff 20. In the second embodiment, the second arm cuff 20 is identical to the first arm cuff 2. In this embodiment, the supporting base 1 comprises a first cuff groove 16 and a second cuff groove 17 which are positioned opposite each other on the supporting base 1 about the central axis 13. The first arm cuff 2 is positioned within the first cuff groove 16 and the second arm cuff 20 is positioned within the second cuff groove 17. All other aspects of the present invention are as previously described.

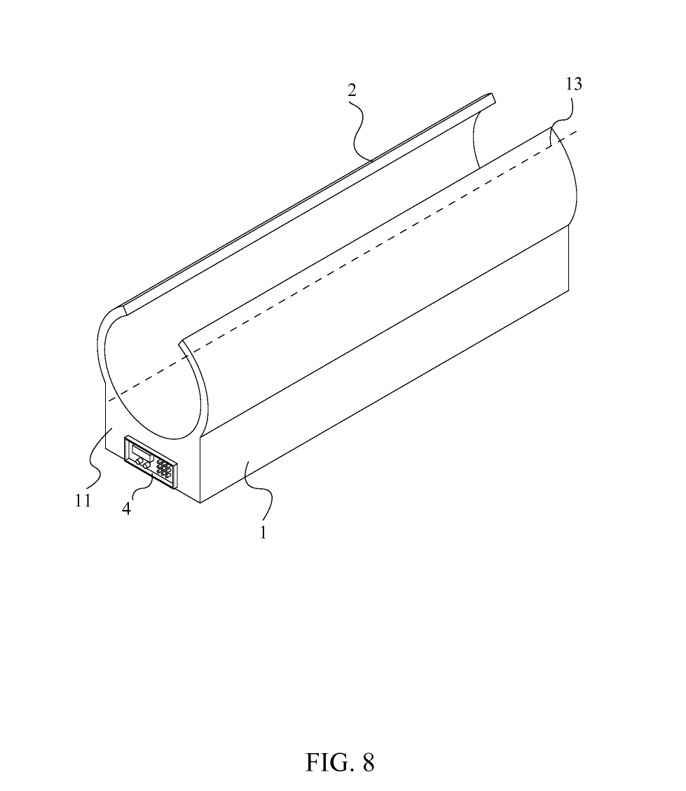

In a third embodiment seen in FIG. 8, the arm cuff 2 does not move between a left position and a right position, but rather is stationary and connected atop the supporting base 1 parallel to the central axis 13. In this embodiment, the control panel 4 is preferably positioned on the first end 11 of the supporting base 1, but the positioning of the control panel 4 is not of particular importance and the control panel 4 may be positioned atop the supporting base 1 or on one of the lateral sides of the supporting base. In the third embodiment, the arm cuff 2 may open and close or may have a slot for inserting the user's arm as previously described. This embodiment preferably does not have a cuff elevating mechanism, and the arm cuff 2 does not move at all aside from opening and closing for insertion of the user's arm. This stationary embodiment may also have a second arm cuff to massage both forearms and hands simultaneously.

Although the invention has been explained in relation to its preferred embodiment, it is to be understood that many other possible modifications and variations can be made without departing from the spirit and scope of the invention as hereinafter claimed.

What is claimed is:

1. A portable arm massager comprises:
a supporting base with a first end and a second end, wherein the first end and the second end are positioned opposite each other on the supporting base along a central axis of the supporting base;
an arm cuff;
a plurality of massaging rollers;
a control panel;
a chipset;
a power source;
the arm cuff and the control panel being connected to the supporting base; and
the plurality of massaging rollers being positioned within the arm cuff.

2. The portable arm massager as claimed in claim 1 comprises:
a cuff support;
the supporting base comprises a first support arm and a second support arm;
the first support arm and the second support arm being oriented perpendicular to the central axis;
the first support arm being positioned at the first end of the supporting base;
the second support arm being positioned at the second end of the supporting base;
the cuff support being oriented parallel to the central axis;
the cuff support being rotatably fixed between the first support arm and the second support arm, wherein the cuff support is translationally fixed and allowed to axially rotate; and
the arm cuff being fixed to the cuff support, wherein rotating the cuff support by a desired angle also rotates the arm cuff by the desired angle.

3. The portable arm massager as claimed in claim 1 comprises:
the arm cuff traversing across the supporting base from the first end to the second end;
the arm cuff comprises a first cuff portion, a second cuff portion, and a hinge; and
the first cuff portion and the second cuff portion being hingedly connected to each other by the hinge, wherein the arm cuff opens and closes by rotating the first cuff portion and the second cuff portion relative to each other about the hinge.

4. The portable arm massager as claimed in claim 1 comprises:
the arm cuff being oriented parallel to the central axis;
the arm cuff being connected atop the supporting base; and
the control panel being positioned on the first end of the supporting base.

5. The portable arm massager as claimed in claim 1, wherein the plurality of massaging rollers is distributed across an internal surface of the arm cuff.

6. The portable arm massager as claimed in claim 1 comprises:
each of the plurality of massaging rollers comprises a roller activation mechanism, wherein the roller activation mechanism enables one of the massaging rollers to be maneuvered for massage purposes;
the chipset, the control panel and the roller activation mechanism of each of the plurality of massaging rollers being electrically connected to the power source; and
the control panel and the roller activation mechanism of each of the plurality of massaging rollers being electronically connected to the chipset.

7. The portable arm massager as claimed in claim 1 comprises:
a second arm cuff comprising a first cuff portion, an upper cuff portion, and a hinge,
wherein the second arm cuff is identical to the first arm cuff;
wherein the plurality of massaging rollers is additionally distributed across an internal surface of the arm cuff and of the second arm cuff;
the supporting base comprises a first cuff groove and a second cuff groove;
the first cuff groove and the second cuff groove being positioned opposite each other on the supporting base about the central axis;
the first arm cuff being positioned within the first cuff groove; and
the second arm cuff being positioned within the second cuff groove.

8. The portable arm massager as claimed in claim 1 comprises:
the arm cuff comprises a main section and an extension section;
the main section being positioned adjacent to the first end;
the extension section being positioned adjacent to main section opposite the first end and adjacent to the second end; and
the extension section being slidably connected to the main section, wherein the extension section is allowed to translate away from the main section in order to increase a total length of the arm cuff.

9. The portable arm massager as claimed in claim 1 comprises:
a cuff elevating mechanism;
the cuff elevating mechanism being operatively connected between the cuff and the supporting base;
the cuff elevating mechanism being positioned at the first end of the supporting base, wherein the cuff elevating mechanism elevates the end of the arm cuff adjacent to the first end of the supporting base;
the cuff elevating mechanism being electrically connected to the power source; and
the cuff elevating mechanism being electronically connected to the chipset.

10. The portable arm massager as claimed in claim 9, wherein the cuff elevating mechanism is positioned at the first end of the supporting base, wherein the cuff elevating mechanism elevates a main section of the arm cuff adjacent to the first end of the supporting base.

11. The portable arm massager as claimed in claim 1, wherein the control panel comprises a plurality of preset buttons.

12. The portable arm massager as claimed in claim 1, wherein the control panel is an electronic touchscreen.
